(19) United States
(12) Patent Application Publication
(10) Pub. No.: US 2021/0357998 A1
(43) Pub. Date: Nov. 18, 2021

(54) VibesR

(71) Applicant: Jesse Chukwuemeka Daniels, Newark, NJ (US)

(72) Inventor: Jesse Chukwuemeka Daniels, Newark, NJ (US)

(21) Appl. No.: 16/876,315

(22) Filed: May 18, 2020

(51) Int. Cl. G06Q 30/06; H04L 29/08; H04L 29/06; H04W 4/20; G06Q 20/32

(52) U.S. Cl. CPC G06Q 30/0601; H04L 67/10; G06Q 20/325; H04W 4/20; H04L 65/403

(57) ABSTRACT

The present invention relates to a new and useful improvements for a soundtrack marketplace that enables producers to upload soundtracks to the cloud for artistes and songwriters to access, purchase and use on the mobile application. The virtual live system connects musicians and music producers together to collaborate on recording a music no matter how far apart they are.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention relates generally to the field of musical apparatus. More specifically, the present invention relates to a marketplace that enables producers to upload soundtracks to the cloud for artistes and songwriters to access, purchase and use on the mobile application.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof; to anything stated or implied therein or inferred thereupon.

Little more than a decade ago, remote collaboration (RC) seemed an expensive, if not unattainable dream. The infrastructure was costly to install and maintain, and the setup required specialised technicians and equipment. Studios at both ends required ISDN technology and the reliability of these systems wasn't always great. In fact, the financial cost of installation and maintenance would often be greater than that of flying the artists and performers in for a session, but the ‘future is here’ cool factor of Transatlantic sessions meant high-end studios could pass the costs on to high-calibre clients, who could command big production budgets. ISDN remains in use, particularly in the broadcast sector, where there's commonly a need to facilitate real-time collaboration between multiple parties in several locations. For the rest of us, the advent of affordable and fast Internet connections, and the proliferation of reasonably priced recording equipment, has changed everything.

The last few years have seen long-distance recording projects using this technology blossom, and not only for the hobbyist: the steady decrease of record-production budgets across the board makes the RC approach particularly attractive to commercial artists and producers, as work can often be completed quicker and more cheaply. But while this financial efficiency is a factor, there's a much greater benefit: it's now possible to access an almost endless pool of creative and musical talent that would be impossible to utilise if everyone had to be in the same room at the same time.

Some web-based options provide for musicians to collaborate on projects, but do not provide for collaborative groups or virtual bands. These sites provide for only one single track to be uploaded, not multiple tracks at the same or similar time from the same collaborative group. By way of example, this might be a guest artist performing with an existing band on one track. Thus, there remains a need for online, collaborative group music compositions for multiple tracks. Also there remains a need for selective grouping and multiple group collaborations on an ongoing basis with these methods.

Realizing these issues, certain systems and methods were developed to allow for near real-time music collaboration via a global computer network. For example, U.S. Pat. No. 6,898,637, issued May 24, 2005 to Curtin, discloses a method and apparatus that allows multiple musicians at various locations to collaborate on a musical work and provide near real-time feedback of the collaborative work to the musicians. The system disclosed in Curtin provides a server and a plurality of musicians/clients. An audio signal is generated by each of the clients and transmitted to the server, where the each of the signals are mixed together and transmitted back, as a collaborative work, to all of the musicians/clients. As a result, each of the musicians receive, and can listen to, an audio mix of all the individual audio signals in near real-time.

The present invention seeks to eliminate, or at least mitigate, the limitations and disadvantages of such known method, or at least provide an alternative. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the method and system of this invention focuses to a virtual live system that connects musicians and music producers together to collaborate on recording a music. And the mobile app allows musicians or artists to record, rehearse, and compose real music using the free or paid soundtracks bought from producers on the same app.

Another embodiment of the present invention is marketplace that enables producers to upload soundtracks to the cloud for artistes and songwriters to access, purchase and use on the mobile application.

More particular still, the invention relates to a system for permitting participants to collaborate in the performance of music

It is another object of this invention to provide artists or musicians access to chatbox or music sharing system through the app.

Briefly, it is a principal object of the invention to provide the following features through the app:
a. Producers publish free and paid soundtracks on the sound marketplace application
b. Artistes access free or paid soundtracks on the application
c. Artistes click on ‘record’ to begin rehearsing with or singing to soundtracks on the spot
d. Artistes share recorded files with producers through chat system for modifications of beats or opening of recording session
e. Producers listen to recorded files on the app and open a studio recording session for artistes to begin virtual live recording
f. Artistes and producers put on VR system to connect virtually for music recording session no matter the distance.

It is yet another important object of the present invention to provide an information storage medium, in which a computer program is stored for the program producer.

It is the object of this invention to make it possible for a plurality of musicians to perform and collaborate in real time, even at remote locations, and produce flawless recordings of that collaboration.

Another aspect of the present invention is to provide methods for creating and editing collaborative music compositions via a computer network, including remote uploading tracks by musicians. The invention provides methods for creating and joining a band, at least one musician to join a virtual group of at least one other musician for the purpose of virtual collaborative creating and/or editing music tracks remotely, via an online network and interactive web site therefor.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a full view of the invention showing the concept.

FIG. 200 shows the concept of the invention.

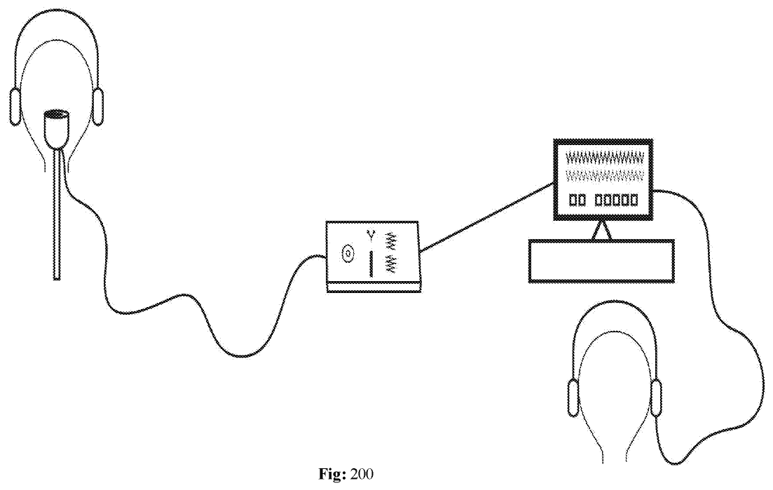

FIG. 300 shows the screens.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention is that it relates to a music soundtracks marketplace with artistes, songwriters and producers virtual collaboration and music recording capabilities. The invention is a marketplace that enables producers to upload soundtracks to the cloud for artistes and songwriters to access, purchase and use on the mobile application.

In some embodiments, the invention relates to following methods of a mobile recording software that allows musicians or artists to record, rehearse, and compose real music using the free or paid soundtracks bought from producers on the same app.

The present invention allows an easy and inexpensive way for producers to open a virtual live recording session for artistes using Virtual Reality system to make real music anywhere in the world, no matter the distance; this way artistes may no longer necessarily go to the studio for recording sessions and producers may not be required to be present at artistes' locations for music making.

The app allows the following features:
a. Producers publish free and paid beats on the beats marketplace
b. Artistes access free or paid beats on the application
c. Artistes click on ‘record’ to begin rehearsing with or singing to beats on the spot
d. Artistes share recorded files with producers through chat system for modifications of beats or opening of recording session
e. Producers listen to recorded files on the app and open a studio recording session for artistes to begin virtual live recording
f. Artistes and producers to connect virtually for music recording session no matter the distance

The music performance system comprises a communication network, a music data distributor and a program reproducer, and the music data distributor and program reproducer are connected to the communication network.

Also the present invention provides for methods for online music collaboration including the steps of providing an interactive mobile app accessible via a network, wherein the app is for creating a collaborative music composition; and wherein the musician entities are self-selectively combinable to form at least one virtual band for online music creation, editing, and social network-based distribution through the mobile app.

On a band's page within the app, where multiple versions or tracks of a song exist, the band can select a default track to be listed on the webpage. Any track can be designated private or public by the band or a musician, thereby making it automatically non-downloadable or downloadable, respectively.

Musicians and bands may further upload and/or add music to their profile page, including tracks, songs, and playlists. Listeners may also create playlists and post to their page. Further, uploaded photos may be managed, reordered, associated with other users, songs, tracks, or playlists, identified as the profile page main photo, shared, and/or downloaded, if the user allows for downloads and shares.

Another embodiment of the invention may incorporate permit real-time functions and software such as a visualizer that can connect to the playing of music, real-time audio, video and/or text communication, and virtual jam sessions. By providing virtual access to users through the application, virtual band members may create virtual tracks or by combining uploaded tracks with live, real-time recordings.

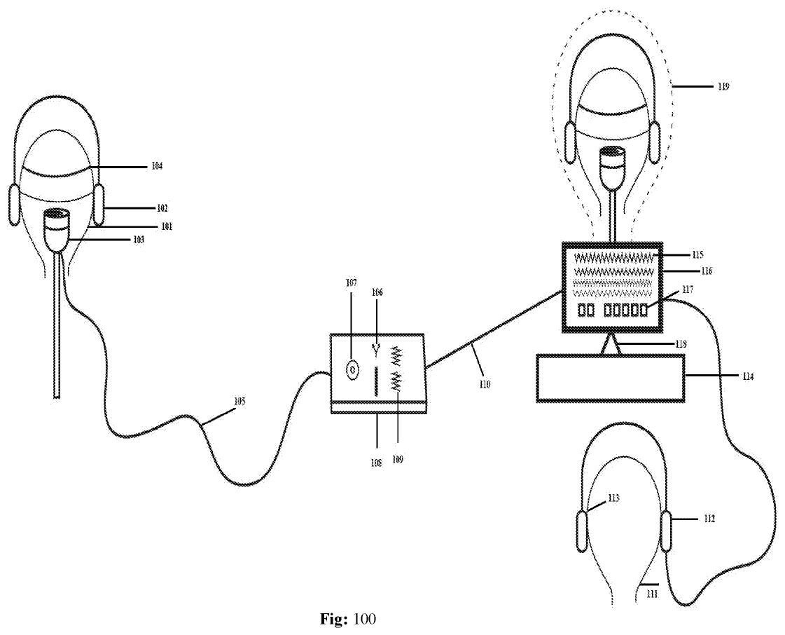

FIG. 100 shows the following:
101. Singer in his/her home/room
102. Singer's Headphone
103. Singer's Condensed Microphone
104. Singer's Virtual Reality Set
105. Singer's Microphone cord connected to the singer's phone
106.VibesR Play Icon during recording
107. VibesR Record Button
108. Singer's phone or media gadget
109. VibesR Soundwave During Recording
110. Shows the relationship between singer's phone or media gadget and producer's studio computer during recording session no matter distance between singer and producer i.e. the producer can be in the United Kingdom while a singer can be in United States
111. Producer in his studio
112. Producer's Headphone
113. Producer's Virtual Reality System
114. Producer's Studio Console Desk
115. Multi-Track Soundwave of singer's Record from VibesR on Producer's Computer
116. Producer's studio computer
117. files and VibesR software components as shown on a producers computer screen
118. Producer's computer stand
119. Singer's similitude which appears to the producer right in the studio and vice vase. This process with the help of headphones and virtual reality system, makes communication and participation during the recording sessions very seamless and relative to live appearances.

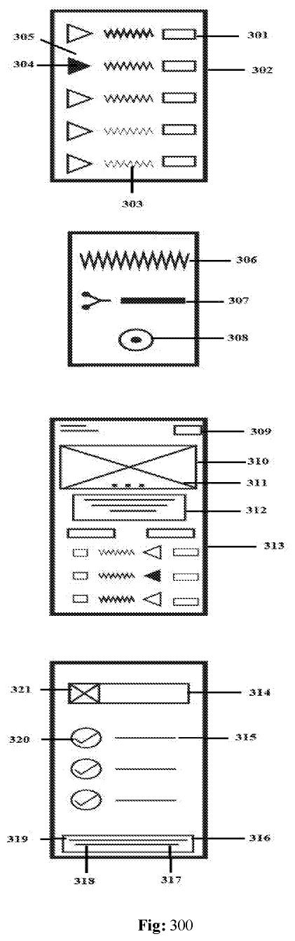

FIG. 300 shows the following:
301. Buy/Record Button
302. Media/Record Screen
303. Sound track details
304. Media Play Icon
305. Attached document
306. Sound wave
307. Media Seeker
308. Record Icon
309. User account Icon
310. Media Slider
311. Advert/Artwork
312. Advert/Information
313. Menu Icon
314. Recorded Sound file
315. Producer Detail
316. Share with producer button
317. Checked producer name
318. Recorded file name
319. Saved record button
320. Producers image
321. Song artwork

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A system for displaying music, comprising a marketplace that enables producers to upload soundtracks to the cloud for artistes and songwriters to access, purchase and use on the mobile application.

2) a virtual live system that connects musicians and music producers together to collaborate on recording a music virtually.

3) An interactive mobile recording software that allows musicians or artists to record, rehearse, and compose real music using the free or paid beats bought from producers on the same app.
